(19) United States
(12) Patent Application Publication
(10) Pub. No.: US 2004/0129636 A1
(43) Pub. Date: Jul. 8, 2004

(54) Metal removal and recovery by liquid-liquid extraction

(76) Inventors: Bruce F. Monzyk, Delaware, OH (US); H. Nick Conkle, Columbus, OH (US); Timothy M. Werner, Traverse City, MI (US); J. Kevin Rose, Millersport, OH (US); Satya P. Chauhan, Columbus, OH (US)

Correspondence Address: Klaus H. Weismann, Battelle Memorial Institute, 505 King Avenue, Columbus, OH, 43201-2693, US

(21) Appl. No.: 10/626,500

(22) Filed: Jul. 23, 2003

Related U.S. Application Data
(60) Provisional application No. 60/397,994, filed on Jul. 23, 2002.

(51) Int. Cl. B01D 11/04

(52) U.S. Cl. 210/634; 210/638; 210/639; 210/511

(57) ABSTRACT

Liquid-liquid extraction recovery of hexavalent chromium from surface finishing process water has been demonstrated. Cr(VI) levels in the clean water (i.e., raffinate) were low enough for discharge to surface waters. Landfill disposal is avoided. Toxic metal recycle enables continued use of high performance toxic metals such as chromium especially in aerospace applications.

### PRIORITY CLAIM

This application claims the benefit of Provisional Application No. 60/397,994, filed Jul. 23, 2002.

The entire contents and disclosure of the provisional application are incorporated by reference as if completely rewritten herein.

### STATEMENT OF GOVERNMENT RIGHTS

The invention was made under contract with an agency of the United States Government under contract No. F08635-90-C-0064 and contract No. F08637-00-C-6011. The United States Government has certain rights in this invention.

### FIELD OF THE INVENTION

This invention relates to the extraction and recovery of metal ions from aqueous solutions using liquid-liquid extraction. Negatively charged metal ions are removed, concentrated and recovered by liquid ion exchange, positively charge metal ions are removed by colloidal capture. The detoxified water is ready for further treatment, direct discharge, or recycle and reuse.

### BACKGROUND OF THE INVENTION AND COMPARISON

Wastewater from metal finishing operations often contain dilute toxic metal anions (such as hexavalent chromium in the form of bichromates, dichromates, and chromates; arsenates and arsenites; selenates; borates; uraninates, etc.) and cations (such as copper, nickel, zinc, cadmium, lead, silver, trivalent chromium, aluminum, etc.). These metal contaminants render the water toxic and unsuitable for discharge to sanitary wastewater treatment plants, direct discharge to receiving waters, or for recycle and reuse.

Conventionally, these wastewaters are treated to reduce the various metal ions to states more amenable to recovery. They are then mixed with caustic to raise the pH and form insoluble metal hydroxides. These hydroxides precipitate and are flocculated, settled, thickened, dewatered, and disposed of in hazardous waste landfills. Solid resin ion exchange is another conventional route for cleanup of metals contaminated wastewaters. But, eventually the resins become loaded and must be regenerated at a distance site or the wastewater treatment site. Strong caustic (e.g., NaOH) is passed through the anion resin bed exchanging Na for the cationic metals. Strong mineral acid (e.g., H₂SO₄) is passed through the cation resin bed exchanging hydrogen ions for the anionic metals. The beds are subsequently flushed with water. The ion exchange beds are effective in removing the metals, but generate a large wastewater stream during regeneration which must be processed—usually by the conventional caustic precipitation route ultimately producing a similar volume of hazardous waste.

Tertiary amines and metal complexion and chelating agents have been used heretofore for the recovery and/or purification of specific metals during the hydrometallurgical extraction of metals ores. For example, Henkel reports the extraction of hydrometallurgical leach solution containing 8,200 mg/L of dichromate (Cr₂O₇⁼). The pH was adjusted to 3 with sulfuric acid. Five volumes of feed stream were extracted with four volumes of extraction solution, an aqueous/extraction solution (A/E) volume ration of 1.25. A low A/E ratio was used because extraction efficiency drops as the A/E ratio is raised. Three stages of extraction were performed. The extraction solution included 4.8 volume % tri-caprylyl (Alamine® 336), 2 volume percent isodecanol, and 93 volume % kerosene. The loaded extraction solution phase was stripped with caustic. If recycled a concentration as high as 37,500 mg of Cr/L could be achieved in the chromium concentrate. The detoxified water, called the raffinate, contained 41 mg/L of the dichromate for a 99.5% reduction.

In U.S. Pat. No. 3,821,351, Lucid reports the extraction of a copper sulfate solution containing 840 mg/L of copper. The pH was adjusted to 3 using sulfuric acid or 9.3 using ammonium hydroxide. Equal volumes of feed and extraction solution (A/E=1) was mixed for 10 minutes (the equivalent of multiple stages of a short contact extractions). The extraction solution contained 5 volume % N-cyclohexyl benzo hydroxamic acid (0.045 M), 5 volume % tridecanol, and 90 volume % kerosene. The raffinate still contained 740 mg/L of copper at a pH of 3 (11% reduction), but only 20 mg/L of copper (97.6% reduction) at a pH of 9.3. Thus, operation under acidic conditions typical of surface finishing operations would not be successful without pH adjustment. Operation at such low A/E ratios would require large detoxification equipment sizes and high capital costs.

In U.S. Pat. No. 4,975,253, Monzyk reports the extraction of a cobalt and nickel solution containing 647 mg Co/L and 713 mg Ni/L. The pH was adjusted from 4.5 to 7.7 using NaOH. An A/E ratio of 0.75 was used. The extraction solution contained 10-wt % of N-methyl decano hydroxamic acid, 4.5 wt % isodecanol, and 86 wt % kerosene. The raffinate contained 6 mg Co/L and 6 mg Ni/L (99.1% reduction). The extraction solution phase was stripped at a pH near 0 with sulfuric acid allowing 99.6 and 97.7% Co and Ni recovery, respectively. Operation under acid conditions typical of surface finishing operations would not be successful without pH adjustment. Again, operation at such low A/E ratios would require large detoxification equipment sizes and high capital costs.

Thus, in all three cases, the focus was on metals recovery not raffinate detoxification. Even with high extraction efficiency, and low A/E ratios, the concentrations of metals in the raffinate were too high to meet discharge limits.

Typical US Federal and a few local discharge limits, based on the State of Georgia and New York are noted in Table 1.

TABLE 1
Allowable Monthly Average Discharge Concentrations

| | Discharge Concentrations, mg/L | | |
|---|---|---|---|
| | | Robins AFB, | Watervliet Army |
| | US Federal | Georgia (daily | Arsenal, NY* |
| Metal | (40 CFR 433) | discharge) | (monthly limit) |
| Cr(VI) | No limit | No limit | 0.3 |
| Cr-total | 1.71 | 0.30 | 3.0 |
| Cu | 2.07 | 0.20 | No limit |
| Ni | 2.38 | 0.50 | No limit |
| Zn | 1.48 | 0.30 | No limit |
| Cd | 0.26 | 0.10 | 0.15 |
| Pb | 0.43 | 0.25 | 0.60 |
| Ag | 0.24 | 0.025 | — |

The focus of this invention is the detoxification of the contaminated aqueous output from various sources typified but not limited by metal finishing operations. Metal levels in the feed are typically relatively modest, containing concentrations of single digits to hundreds of mg/L, and are therefore constitutes a waste rather that a valuable feedstock. The invention discloses the extraction and detoxification of the aqueous stream to produce raffinates typically with sub 1-mg/L metal levels suitable for direct discharge or for recycle and reuse

Liquid-liquid extraction has been used for many years for the extraction and recovery of certain metals (e.g., copper, uranium are the two largest applications). The commercial extraction and recovery of Cr is not practiced commercially. Henkel Chemical Co. (now Cognis Corporation) published a bulletin in 1977 called “Liquid Ion Exchange Reagents and Systems: Chromium.” It outlines a process for the extraction of hexavalent Cr from water using the tertiary amine extractant called Alamine 336®. This is the same extractant that has been demonstrated the present invention. However, there are significant differences in the present invention and that outlined in the bulletin as described in more detail herein. The present invention provides for example much higher aqueous solution/extraction solution (A/E) ratios, typically of 4:1 or higher Also the present invention provides for Cr(III) extraction, albeit at a lower but still significant ˜80%.

The conventional route for control of Cr from plating shop wastewater is to chemically reduce Cr(VI) to Cr(III) using sulfur dioxide or bisulfite (in the dry or liquid form). The Cr(III) is precipitated as chromium hydroxide. The precipitate is coagulated and flocculated before being sent to a clarifier. The clean water is discharged from the clarifier while the solids are sent to a thickener. The thickened solids are filtered to removal excess moisture and the filter cake is sent to a hazardous waste landfill for disposal. The present process of the invention has numerous advantages typically including lower chemical usage; less complex process; lower labor requirement; elimination of Cr(VI) sludge production; and reduced sludge handling.

### BRIEF DESCRIPTION OF THE INVENTION

This invention relates to the extraction and recovery of metal ions from aqueous solutions (e.g. surface finishing wastewater) using liquid-liquid extraction. Negatively charged metal ions (anions) such as hexavalent chromium, Cr(VI), in the form of bichromates, dichromates, and chromates; arsenates and arsenites; selenates, borates, uraninates, etc. are ion-paired under acidic conditions with a tertiary amine mixed with a diluent, and a modifier. The ion pair is broken and the metal recovered by increasing the pH with caustic thereby creating a metal salt while regenerating the amine. Positively charged metal ions, such as Cu⁺⁺, Cr⁺⁺⁺etc., are simultaneously extracted by colloidal capture, see discussion below.

### BRIEF DESCRIPTION OF THE DRAWINGS

FIG. 1 is a schematic drawing of a general embodiment of a invention.

FIG. 2 is a schematic drawing of a side view of a mixer settler according to the invention.

FIG. 3 is a schematic drawing of a top view of a typical three stage mixer-settler extraction circuit operated in counter current flow pattern according to the invention.

FIG. 4 is a schematic drawing of a top view of a two mixer settler stripping circuit operating in counter current mode according to the invention.

FIG. 5 is a graph illustrating equilibrium data and efficiency for one embodiment of the present invention.

### DESCRIPTION OF THE INVENTION AND BEST MODE

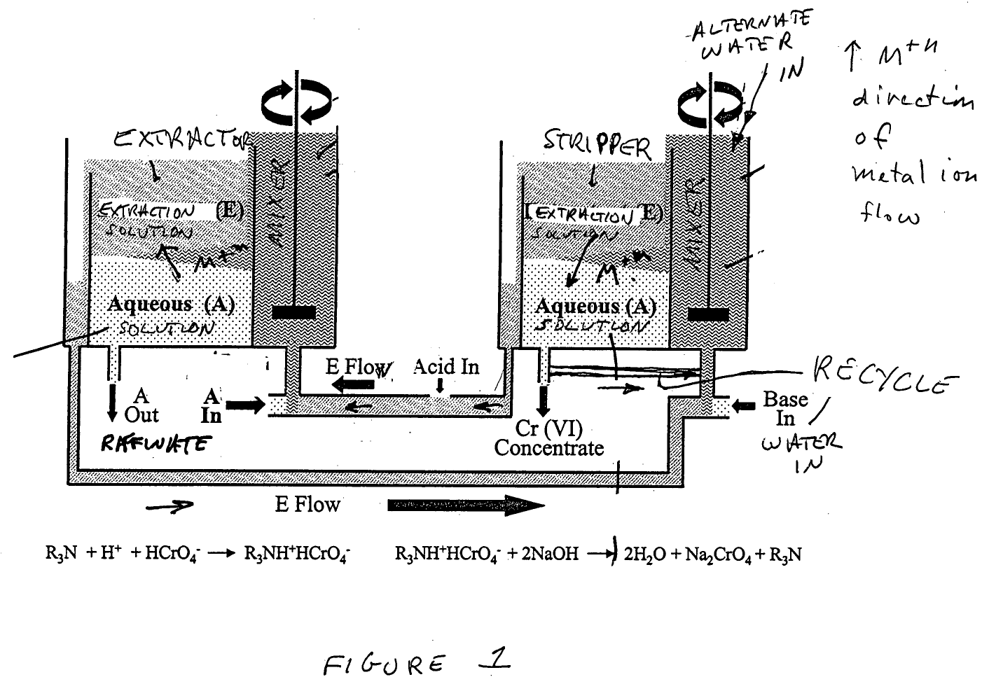

The process of the present invention is shown schematically in FIG. 1. The process can be used in a variety of applications from plating shops to aerospace applications. An aqueous rinse water from a plating shop typically contains many metals. Chromium is typically present as Cr(VI) mostly as the bichromate anion, HCrO₄⁻ with some chromium present as Cr(III) as the ion Cr⁺³, other metal ions are typically present as well. The inventive process employs a series of mixer/settlers to achieve a liquid-liquid extraction of the metal ions.

Definitions

Metal ion as used herein includes cations such as Cr(III) or Cr⁺³, and anions such as oxometal ions (e.g. HCrO₄⁻, Cr₂O₇⁻²)

Extraction solution as used herein is a solution consisting of an extractant, a modifier, and a diluent. The solution is a homogeneous mixture at a molecular scale.

Dilute aqueous solution as used herein means a solution that has less than 1000 ppm of metal ions (typically chromium) therein, in other embodiments it is less than about 200 ppm, and in other embodiments less than about 20 ppm. The dilute solution is typically detoxified to a level less than 1 ppm, on some embodiments less than 0.5 ppm and in other embodiments less than 0.1 ppm.

Product aqueous solution means the final aqueous solution in the stripper portion of the apparatus according to the invention that contains the concentrated metal ions that are desired to be removed. The concentration in the aqueous solution is typically 1 wt % or more and in some embodiments 2 wt % or more.

With reference to FIG. 1, the process is described broadly as follows. Extraction sector 1 and Stripper sector 2 illustrate the overall process. In Extraction sector 1 the an aqueous solution containing chromium is contacted with an extraction solution. The chromium moves into the extraction solution and is held by an extractant. Typically the extraction solution comprises an extractant, a modifier, and an inert diluent. The chromium contaminated aqueous solution is introduced into the first mixer where it is contacted with hydrogen ions, H(+), typically in the form of sulfuric acid, and a tertiary amine (R₃N) extractant. Ion pairing results in capture of the Cr(VI) as part of an oil soluble salt (R₃NH⁺HCrO₄⁻) in the extraction solution. The high interfacial surface area provides fast kinetics even with feed Cr(VI) levels as low as 1 ppm. The extraction solution and cleaned water overflow the mixer into a settler. The Cr-extracted aqueous phase is drawn off the bottom of the settler. The low-density extraction solution separates from the detoxified aqueous solution in the settler and floats to the surface of the settler where it is drawn off and sent to the mixer in the stripper section. In the stripper, sodium hydroxide (NaOH) is added to react with the salt to regenerate the loaded extraction solution (containing loaded extractant) and release the loaded chromate as sodium chromate (Na₂CrO₄). The stripped extractant and Cr concentrate overflow the mixer into the settler. The Cr(VI)-free extractant floats to the surface of the settler, is withdrawn, and is recycled back to the extraction mixer/settler. This continuous regeneration keeps working capital low. The aqueous Cr concentrate is withdrawn from the bottom of the stripper settling-chamber for reuse or recycle.

The preferred extractant used in this process is Alamine® 336. It has been found to be a selective extractant for Cr(VI), even over sulfate ion. Exxal® 10 is added as a modifier to decrease phase separation time and increase the ion-pairing kinetics. To minimize costs and control performance, only a small portion of the extractant phase is actually the amine or the modifier. The extractant phase used in the of apparatus shown in FIG. 1. was typically composed of 5 vol. % Alamine® 336 (Cognis), 5 vol. % Exxal® 10 (isodecanol) (Exxon Chemical, Corp.), and 90 vol. % Conoco® 170 ES aliphatic diluent (Conoco, Inc.).

Typical formulations for liquid extraction solutions for chromium removal from aqueous solutions include the following:

1. Extractant (typically about 0.5 vol. % to about 99 vol. %)

Alamine 336™ (preferred) from Cognis Corporation, or

Aliquat 336™ (less preferred) from Cognis Corporation, and mixtures thereof;

2. Modifier (typically about 0 to about 20 vol. %)

(imposes phase disengagement and enhances extraction)

Exxal 10™ a isodecanol from Exxon Chemical Corp., or

Exxal 13™ a tridecanol from Exxon Chemical Corp., and mixtures thereof;

3. Diluent (typically the balance)

Conoco 170 ES™ aliphatic diluent (preferred) from Conoco Inc., or

Aromatic 150™ Solvents and Chemicals, Inc., Pearland, Tex., or

Calumet 400/500™ Solvents and Chemicals, Inc., Pearland, Tex., and mixtures thereof.

A typical broad embodiment of the extraction solution prepared from the precursors listed above is:

Extractant about 0.5 vol. %. to about 30 vol. %,

Modifier about 0 vol. %. to about 20 vol. %; and

Diluent about 99.5 vol. %. to about 50 vol. %.

A preferred extractant solution prepared from the precursors listed above is typically:

Alamine 336™ about 3 to about 8 vol. %,

Exxal 10™ about 1 to about 10 vol. %; and

Diluent about 96 vol. %. to about 82 vol. %.

A more preferred extractant solution is made up of:

Alamine 336™ about 3 to about 8 vol. %,

Exxal 10™ about 1 to about 10 vol. %; and

Conoco 170™ about 96 vol. %. to about 82 vol. %.

A yet more preferred extraction solution is made up of:

Alamine 336™ about 4 to about 7 vol. %,

Exxal 10™ about 3 to about 7 vol. %; and

Conoco 170™ about 93 vol. %. to about 86 vol. %.

Additional typical formulations for liquid extraction solutions for chromium removal from aqueous solutions include the following:

1. Extraction solution (typically about 4 to about 10 vol. %)

Alamine 336™ (preferred) from Cognis Corporation, or

Aliquat 336™ (less preferred) from Cognis Corporation, a methyl-tricaprylyl ammonium chloride; and mixtures thereof;

2. Modifier (typically about 1 to about 10 vol. %) (imposes phase disengagement and enhances extraction)

Exxal 10™ a isodecanol from Exxon Chemical Corp., or

Exxal 13™ a tridecanol from Exxon Chemical Corp., and mixtures thereof;

3. Diluent (the balance)

Conoco 170 ES™ aliphatic diluent (preferred) from Conoco Inc., or

Aromatic 150™ Solvents and Chemicals, Inc., Pearland, Tex., or

Calumet 400/500™ Solvents and Chemicals, Inc., Pearland, Tex., and mixtures thereof.

Typically the pH range for the extractants in aqueous solutions is at least about 2 to about 6, preferably about 2.5 to about 5, and most preferably about 3 to about 4.

Typically, the extraction solution is mixed with the aqueous solution to be stripped in a ratio of aqueous/extraction solution of about 10:1 to about 1:1. Most preferably the extraction solution is mixed with the aqueous solution to be stripped in a ratio of aqueous/extraction solution of about 8:1 to about 5:1.

Discussion of Colloidal Capture Mechanism for Trivalent Chromium Extraction by Alamine 336 and Similar Extractants.

Unexpectantly, it has also been discovered that cationic extractants could be effective in removing cations from waters containing dilute cations despite both the extractant and the cation being positively charged. The prior art teaches away from such a possibility [e.g. G. M. Ritcey and A. W. Ashbrook, “Solvent Extraction: Principles and Applications to Process Metallurgy”, Part I. Chap. 3, pp 136-145 (Elsevier, 1984)]. Normally cationic extractants are used to extract portions of anionic species at high concentrations from water, rather than portions of cationic species at low concentration. Although not wishing to be bound by any theories, the following rationalization of the mechanism is offered for the discovery.

As tertiary amines are pH basic in their contact with water, and as allowance has been made to control pH via the addition of additional aqueous base (NaOH) or acid (H₂SO₄), the A-LLX process of the invention can be operated at pH values where metal ions (M⁺ⁿ) are hydrolyzed, i.e.

M(H₂O)₆⁺ⁿ=MOH(H₂O)₅⁺⁽ⁿ⁻¹⁾+H⁺ (1)

The higher the pH, and the more dense the positive charge (n, where n=1, 2, 3, 4) on the metal ion, the further right the above reaction shifts at a given pH. Such hydrolysis can be promoted much further to the right for easily hydrolyzed highly charged metal ions such as the +3 (trivalent) metal ions i.e. Cr³⁺, Al³⁺, Fe³⁺, etc. so that eventually anionic compounds form, i.e. for a trivalent cation,

$$\begin{matrix}{[ {M ( {H}_{2} O )}_{6} ]}^{+ 3} {=}^{{– H}^{+}} {[ {MOH ( {H}_{2} O )}_{5} ]}^{+ 2} {=}^{{– H}^{+}} {[ {M ( OH )}_{2} {( {H}_{2} O )}_{4} ]}^{+ 1} = \\ {=}^{{– H}^{+}} {[ {M ( OH )}_{3} {( {H}_{2} O )}_{3} ]}^{0} {=}^{{– H}^{+}} {[ {M ( OH )}_{4} {( {H}_{2} O )}_{2} ]}^{- 1} .\end{matrix} \qquad ( 2 )$$

What is more, the species involved are monomeric initially, but quickly coagulate into molecular or submicroscopic clusters and/or colloids, e.g.

$${m [ {M ( OH )}_{2} {( {H}_{2} O )}_{4} ]}^{+ 1} {=}^{{–m H}^{+}} {[ {M ( OH )}_{3} {( {H}_{2} O )}_{3} ]}_{m}^{0} {=}^{{–q H}^{+}} {[ {M ( OH )}_{4} {( {H}_{2} O )}_{2} ]}_{m}^{- p} \qquad ( 3 )$$

where “m” is the number of trivalent metal ions trapped in the colloid and “q” the number of negative charges present on the colloidal particle. Only a few negative charges are expected per colloidal particle (i.e. m>>q). Increasing pH further, and/or increasing the total metal ion concentration further, enhances the fraction of dissolved contaminant M present as these colloids and the total negative charge per colloidal particle, q. It is believed that the anion extractant then ion pairs with the negative charges on these colloids under anion extraction conditions, which gives rise to colloidal particles “coated” with hydrophobic extractant molecules. Coated as such, and with their negative charges cancelled by the positive charge of the adsorbed cationic extractant molecules, results in extractable species, effectively removing cations from the aqueous phase into the extraction solution phase. In reaction form this is illustrated as follows,

[M(OH)₄(H₂O)₂]^{-p}ₘ+rHR₃N⁺=(R₃N)ᵣ[M(OH)₄(H₂O)₂]^{-p}ₘ (4)

One reason the present invention is able to achieve such low metal residuals appears to be the ability to remove both Cr(III) and Cr(VI).

General Description of One Typical Embodiment

One water insoluble tertiary amine used in the present invention has the general formula, R₃N, where R is a straight chain or branched chain hydrocarbon having between 6 and 12 carbons atoms. Preferable R is an octyl or caprylyl (C8) or decyl (C10) straight chain hydrocarbon. One example of a compound having these properties is sold commercially by Cognis Corp under the trade name Alamine® 336; it is officially listed as tricaprylyl amine. The compound contains a basic nitrogen atom; it can react with a variety of inorganic and organic acids to form amine salts, which are capable of undergoing ion exchange reactions with a host of other atoms. The company literature states it is effective for the extraction of many metals; however, chromium is not included.

The extractant is acidified to protonate the amine in a suitable mixing vessel. Typically, the tip speed of the mixer is about 1.5—about 7.5 m/sec, preferably about 3 to about 5 m/sec, and a residence time of 0.1 to 10 min, preferably about 1 to 2 minutes, suitable to extract the metals without emulsifying the organics. Too short a time gives inadequate mixing and contact and extraction while too long a time gives problems with emulsification and phase separation. The negatively charged anions ion-pair with the positively charged (i.e., protonated) amine. For example, the equation below is provided for the case where the anion is bichromate:

NR₃+H⁺+HCrO₄⁻→NH₃H⁺HCrO₄⁻.

The ion pair is oil soluble and the anion is transferred to the extraction solution. Only a small part of the extraction solution is comprised of extractant. The majority portion is comprised of a diluent, typically an aliphatic or aromatic, intermediate length hydrocarbon like kerosene. A long chain alcohol, called a modifier, can be added to improve phase disengagement, speed the extraction rate, and prevent the formation of a third phase. After mixing, and formation of the ion pair the aqueous and extraction solution (organic phases) are separated based on immiscibility or specific gravity difference. This can be accomplished is a settler, a separation column, or a centrifugal extractor. The detoxified aqueous phase, clear of entrained organics, has a greatly reduced anion content. Anion metal extraction per stage may range from 50 to 99 percent removal. Therefore, multiple-stage, counter-current processing with two or more stages may be devised to achieve the desired raffinate anion level, typically in the sub 1 mg/L level. The clean raffinate may be sent for further processing, discharged to a receiving water, or recycled for reuse. The metal laden extraction solution (organic phase) is treated with a basic stripping agent such as NaOH, Na₂CO₃, NH₃, or NH₄ClO₄. For example, the equation below is provided for the case where the anion is bichromate and the stripping agent sodium hydroxide (NaOH):

NR₃H⁺HCrO₄⁻+2 NaOH→Na₂CrO₄+2H₂O+NR₃.

The reaction is conducted in a suitable mixing chamber. Water-soluble metal salts (Na₂CrO₄ in the example) passes to the aqueous phase while the amine extractant is regenerated. The aqueous and extraction solution (organic phases) are separated based on immiscibility or specific gravity difference. This can be accomplished is a settler, a separation column, or a centrifugal extractor. The regeneration efficiency with caustic is 90 to 99%, so two stripping stages operated in a counter current mode can be employed to achieve over 99% extractant regeneration. The regenerated extraction solution is pumped to the extraction circuit. The aqueous metal solution, called the concentrate, is internally recycled from the collection box to the mixing chamber to improve stripping. The metal concentration will build until salts begin to precipitate or until the solution is removed. A concentration factor, anion concentration in the concentrate/anion concentration in the feed, of 1000 to 3000 times can be achieved. By adding a continuous stream of water to the stripping circuit it is possible to force a constant discharge of the anion concentrate from the circuit to a concentrate collection vessel. For the example above, hexavalent chromium is recovered as sodium chromate. This material can be used in the steel industry. The sodium chromate can be used for sealing the surface of aluminum after anodizing or returned to the chromium-plating bath. If necessary, the sulfate level can be reduced by first contacting the concentrate with barium chloride and removing the precipitated barium sulfate. Also, special sulfate removal ion-exchange resins are available to remove the sulfates. If undesirable cations are collected with the concentrate, such as iron or zinc, the aqueous concentrate can be passed through a cation ion-exchange column for regeneration of the chromic acid.

Another typical embodiment includes the following. An extraction solution is prepared with three components. The first is the extractant. For anion extraction, the preferred extractant is a tertiary amine, NR₁R₂R₃, where R₁, R₂, or R₃ may be the same or different and are selected from the group R₁═C₁-C₁₈, R₂═C₁-C₁₈, and R₃═C₁-C₁₈, total Cn is 9-40, and preferred is R₁═R₂═R₃═C₈-C₁₀. A representative compound is Alamine ® 336 sold by Cognis Corporation. Another preferred extractant is NR₁R₂R₃R₄, where R₁, R₂, R₃, or R₄ may be the same or different and are selected from the group R═C₁-C₁₈, R₂═C₁-C₁₈, R₃═C₁-C₁₈ and R═C₀-C₁₈, total Cn is 9-40, and preferred is R₁═R₂═R₃═C₈-C₁₀ with R₄═H; or in another preferred embodiment is R₁═R₂═R₃═C₈-C₁₀ with R₄═CH₃. A representative compound is Aliquat ® 336 sold by Cognis Corporation.

The second part of the extraction solution is an inert, water immiscible diluent. The diluent reduces the viscosity of the extraction solution for ease of mixing, separation, and flow. It also allows more thorough distribution of extraction solution (and thus extractant) throughout the aqueous phase and prevents organic solids from forming and solubilization of the metal extractant complexes. The diluent is also much lower cost than the extractant and so lowers the overall cost of extraction solution. A non-exclusive list of some suitable diluents include high flash point aliphatic and aromatic hydrocarbons, such as kerosene, hexane, heptane, fuel oil, iso-octane, mineral oil, Conoco 170 Exempt Solvent (an aliphatic C12-C15 hydrocarbon), Aromatic 150 (an high flash point aromatic hydrocarbon), Calumet 400/500, and Kurmet 470. The final component is a modifier that serves to promote rapid disengagement of the aqueous and extraction solution (organic phase) and to increase the ion-extractant bond formation kinetics. A non-exclusive list of some suitable modifiers includes isodecanol (Exxal 10), tri-decyl alcohol (Exxal 13), capryl (C₈) alcohol, and tri-n-butyl-phosphate. Generally, the tertiary amine will be present in the extraction solution (organic phase) in an amount sufficient to extract 50 or more percent of the ion, per pass, from the aqueous feed stream.

The invention is further described by the following examples which are illustrative only and do not constitute limitations on the invention.

### EXAMPLE 1

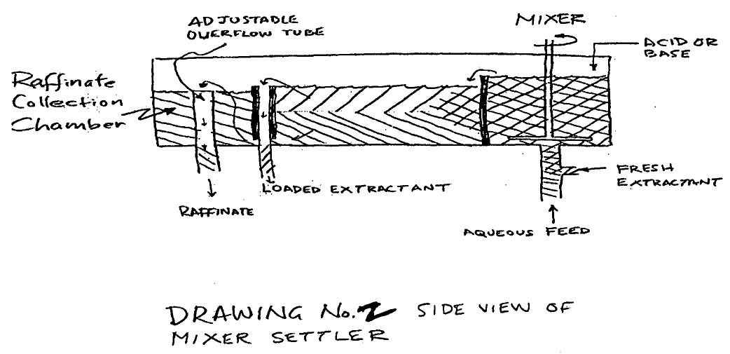

An extraction solution was prepared with 90 wt % Conoco 170 Exempt Solvent (aliphatic C₁₂-C₁₅, straight chain hydrocarbon), 5 wt % Exxal®10 (isodecanol), and 5 wt % Alamine® 336 (NR3 where R is a C₈ or C₁₀ straight chain hydrocarbon). The extraction solution is pumped at 1 gal per minute (gpm) into a port leading to the bottom inlet to an 18-×18-×16-in. deep mixing box fitted with a 9-in. diameter mixing disk located 0.5-in. from the floor of the box, see FIG. 2. A feed port is connected to the bottom center of the mixing box. The rotation of the mixing disk forms a vacuum effectively drawing 6 gpm of feed solution into the mixing box for an A/E ratio of 6/1.

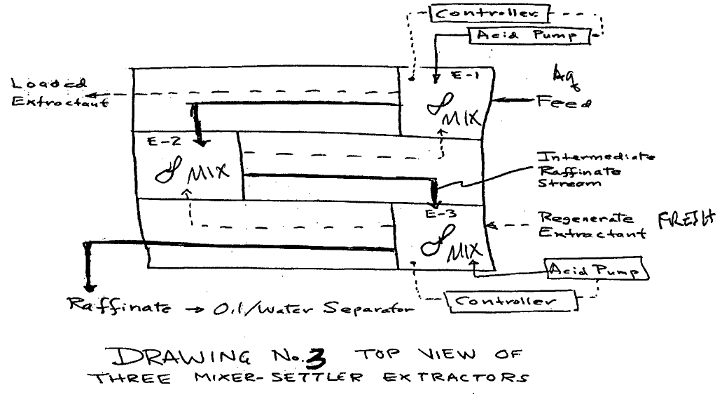

The feed was mixed with the extraction solution with an agitator rotation of 145 rpm or a tip speed of 3 m/sec and a residence time of 2 minute to form small, 1/8-in. diameter globules. Fifty wt % sulfuric acid was added automatically to control the pH at about 3. The mixture overflowed the mixing box into a 66.5-×18-×16-in. deep settling chamber. The mixture flowed through a series of lattice-type flow straightners to promote aqueous/extraction solution (organic phase) disengagement. At the end of the settling chamber the denser aqueous phase passed under a weir and entered the collection chamber. An adjustable raffinate overflow tube was set at a height to maintain the extraction solution/aqueous levels in the settling chamber at a 1/2 ratio, refer to FIG. 1. The once-cleaned raffinate overflowed into the tube and was drawn into Extractor No. 2. The flows of the feed, extraction solution, and raffinate through the three-stage, counter-current extraction circuit are shown in FIG. 3.

Extraction solution from Extractor No. 3 (E-3) overflowed the collection weir and was drawn into the bottom of the E-2 mixer. The E-1 raffinate and E-3 extraction solution were mixed and passed in a similar manner to the end of the E-2 Settler. The separated E-2 raffinate flowed to the E-3 mixer and the E-2 extraction solution flowed to the E-1 mixer. The pH level in E-1 and E-3 were automatically adjusted to ˜3 level using two pH probes and two pH controllers that activated separate sulfuric acid pumps. The extraction step was repeated and the E-3 raffinate discharged from the system. The raffinate was collected and passed through an oil/water (O/W) separator to remove the last traces of entrained extraction solution (organic phase). The results of a series of tests at various feed Cr(VI) levels are noted in Table 2.

TABLE 2

| Feed | | | Final Raffinate | |
|---|---|---|---|---|
| Cr(VI), mg/L | PH | A/E | Cr(VI), mg/L | Stripper pH |
| 12.8 | 2.7 | 6/1 | 0.04 (99.7% | 12.9 |
| | | | removal) | |
| 16.0 | 2.7 | 6/1 | 0.11 (99.3% | 13.4 |
| | | | removal) | |
| 55.0 | 2.7 | 8/1 | 0.8 (98.6% | 13.4 |
| | | | removal) | |
| 7.6 | 2.7 | 7/1 | 0.17 (97.8% | 13.3 |
| | | | removal) | |

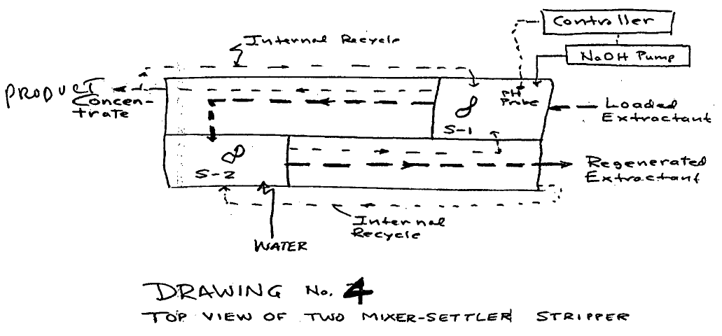

The loaded extraction solution was drawn into the first of two mixer-settlers to regenerate the extractant therein by stripping the chromium from the amine, see FIG. 4.

The loaded extractant was mixed with 25 wt % NaOH. The pH was automatically controlled to a pH level of about 13. The mixture overflowed the mixing box into a settling chamber of the same dimension as the extraction system. At the end of the settling chamber the denser aqueous phase, the concentrated chromium solution, passed under the weir and filled the concentrate collection chamber. An adjustable overflow tube was set to a height to maintain the extraction solution/aqueous level in the settling chamber at a 2/1 ratio (in contrast to the extraction settling chamber where the extraction solution/aqueous level was 1/2. The Stripper No. 1 (S-1) loaded extraction solution containing extractant flowed to S-2 where it was cleaned again. The regenerated extractant was returned to an extractant feed tank and then pumped to the extraction circuit. To promote extraction, a portion of about 10% to about 99% of the aqueous phase was internally recycled (i.e. from the aqueous output of the stripper section to the inlet of the stripper section. Water was pumped into the S-2 circuits to push the concentrate out of the S-1 collection chamber. The water inflow rate was set to maintain a constant sodium chromate level in the stripper.

### EXAMPLE 2

Small scale equilibrium tests were conducted to determine the effect of pH and extraction solution composition on extraction rate. Solutions with Cr(VI) concentrations from 10 to 156 mg/L were prepared and extracted at a pH of 3, 3.5, and 4. Data for a feed of 19.5 mg/L and an A/E ratio of 5 are presented in Table 3.

TABLE 3

| | Cocktail, wt % | | | |
|---|---|---|---|---|
| | Extractant | | Diluent | |
| pH of | (Alamine | Modifier | (Conoco 170 | Final Raffinate |
| Feed | 336) | (Exxal 10) | ES) | Cr(VI), mg/L^{(a)} |
| 3.5 | 5 | 5 | 90 | 0.51 (97.4% |
| | | | | removal) |
| 4.5 | 5 | 5 | 90 | 4.56 (76.6% |
| | | | | removal) |
| 4.0 | 10 | 10 | 80 | 0.37 (98.1% |
| | | | | removal) |
| 3.5 | 10 | 10 | 80 | 0.23 (98.8% |
| | | | | removal) |
| 4.0 | 20 | 20 | 60 | 0.27 (98.6% |
| | | | | removal) |
| 3.5 | 20 | 20 | 60 | 0.23 (98.8% |
| | | | | removal) |

^{(a)}Assuming 3 stages and an 80% stage efficiency in each stage.

The results show adequate protonation of the amine extractant is vital to good extraction efficiency (76.6% removal at a pH of 4.5 versus 97.4% at a pH of 3.5). The results also show a similar but less dramatic pH impact as the percent of amine extractant in the cocktail is increased (98.8% removal at pH of 3.5 versus 98.1% at a pH of 4 with 10% amine content). The test series shows that as the amine level is increased from 5 to 10 to 20% the percent Cr removal initially increases and then levels off (97.4, 98.8, and 98.8% removal at a pH of 3.5).

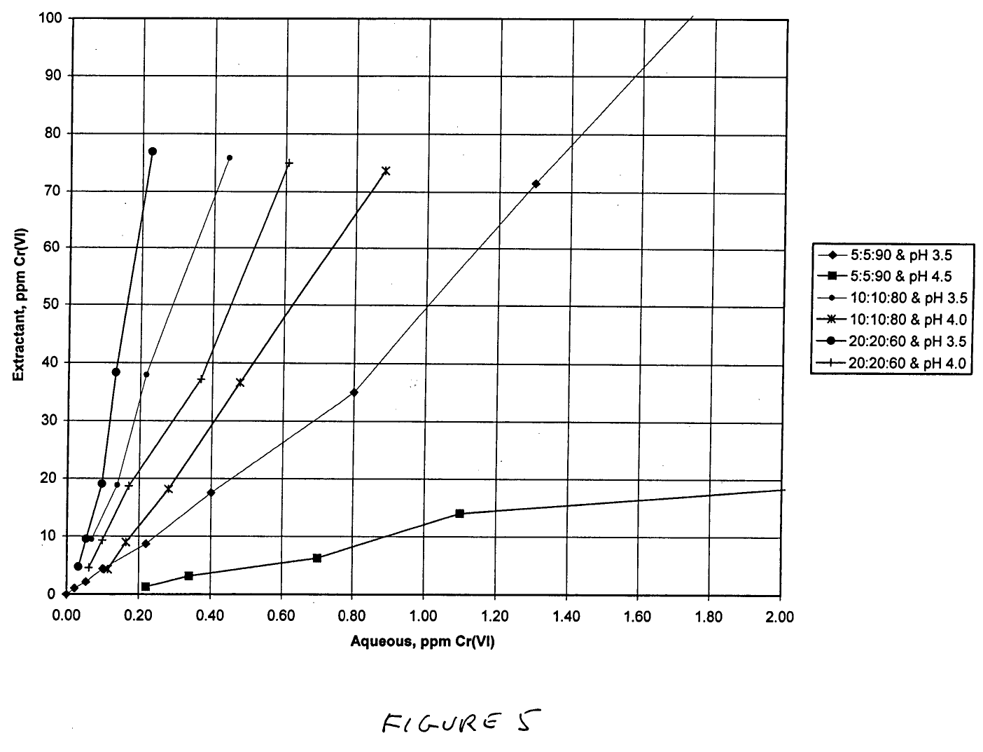

Evaluating the entire series, the preferred conditions are ranked in descending order below and noted on the graph of FIG. 5 (expressed as percent extractant/modifier/diluent and pH):

1. 20/20/60 and 3.5

2. 10/10/80 and 3.5

3. 20/20/60 and 4

4. 10/10/80 and 4

5. 5/5/90 and 3.5

6. 5/5/90 and 4.5.

FIG. 5 is a graph that illustrates equilibrium data for Extractant, ppm Cr(VI), on the vertical axis and Aqueous, ppm Cr(VI) on the horizontal scale. The numbered rankings are also shown on the figure.

With the teachings according to the invention, a McCabe Thiele diagram can be constructed by those skilled in the art. By plotting an A/E ratio of 5/1 for example performance and extraction efficiency can be calculated. To plot the A/E curve for 5/1 fro example go up 5 ppm units on the vertical scale and 1 ppm unit on the horizontal scale. The plotted curves show that the conditions for curve 1, gave the best performance and extraction efficiency. A lower pH gave better efficiency at the conditions tested.

### EXAMPLE 3

The pilot plant described in Example 1 was utilized but the pH in the extraction circuit was raised to 4.5, see Table 4.

TABLE 4

| Feed | | | Final Raffinate | |
|---|---|---|---|---|
| Cr(VI), mg/L | pH | A/E | Cr(VI), mg/L | Stripper pH |
| 12.8 | 2.7 | 6/1 | 0.04 (99.7% | 12.9 |
| | | | removal) | |
| 46 | 4.6 | 6/1 | 4 (91.3% | 13.3 |
| | | | removal) | |

Overall extraction efficiency dropped to 91%. This shows that performance is closely tied to extraction pH and demands close, automated pH control.

### EXAMPLE 4

The same pilot plant was utilized but the A/E ratio was increased from 6/1 to 10/1, see Table 5.

TABLE 5

| | |
|---|---|
| Feed | Final Raffinate |

| Cr(VI), mg/L | pH | A/E | Cr(VI), mg/L | Stripper pH |
|---|---|---|---|---|
| 12.8 | 2.7 | 6/1 | 0.04 (99.7% | 12.9 |
| | | | removal) | |
| 15 | 2.6 | 10/1 | 0.06 (99.6% | 12.8 |
| | | | removal) | |

Overall, the extraction level substantially the same at 99.6% showing that a higher aqueous solution to extraction solution ratio, i.e., a higher A/E ratio, still results in a high extraction efficiency. This illustrates the unexpected result that the higher ratio still gives high extraction. Comparing this to the prior art where A/E ratios of 1:1 or less are the norm, an increase of A/E from 6/1 to 10/1 would result in about a 40-90% reduction in plant size with about the same throughput. On the other hand if the plant size stayed the same and the A/E ratio increased from 6/1 to 10/1 throughput would be about doubled at the same efficiency.

### EXAMPLE 5

The system works effectively when the stripper circuit removes all the chromium from the extractant. The same pilot plant was utilized, but the pH in the stripper was reduced from the nominal 13 to 11, see Table 6.

TABLE 6

| Feed | | | Final Raffinate | |
|---|---|---|---|---|
| Cr(VI), mg/L | pH | A/E | Cr(VI), mg/L | Stripper pH |
| 12.8 | 2.7 | 6/1 | 0.04 (99.7% | 12.9 |
| | | | removal) | |
| 12.8 | 2.7 | 6/1 | 5 (61% | 11 |
| | | | removal) | |

Overall, the extraction level fell to ______%. The lower stripper pH level did not allow the extractant to be fully regenerated. This points out that extraction performance is closely tied to stripper performance. The sensitivity to pH indicates automated pH control is required for acceptable performance.

### EXAMPLE 6

The same pilot plant was utilized. The pH, A/E ratio, and stripper pH were maintained at ˜3, 6/1, and ˜13, respectively, but the temperature of the feed water was increased from 13 to 43° C., see Table 7.

TABLE 7

Feed

| | Feed Water | | Raffinate Oil |
|---|---|---|---|
| | Temperature, | Final Raffinate | and Grease |
| Cr(VI), mg/L | C. | Cr(VI), mg/L | Level, mg/L |
| 8.1 | 13 (55 F.) | 0.04 (99.5%) | 140 |
| 7.6 | 43 (110 F.) | 0.17 (97.8%) | 5 |

The data indicate that the temperature had a minor impact on extraction (decreasing from 99.5 to 97.8% as the temperature was increased), but temperature had a major impact on residual oil and grease levels in the raffinate. The lower oil and grease levels indicate less extractant is being lost with the raffinate, improving operating economics and improving the raffinate quality. Municipalities often limit oil and grease levels to below 10-15 mg/L. Thus operation at higher feed water temperatures is important to meet the discharge limits.

### EXAMPLE 7

The same pilot plant was utilized. The feed pH, A/E ratio, feed water temperature, and stripper pH were maintained at 2.7, 6/1, 16° C., and ˜13, respectively. Examination of the feed and raffinate chromium levels indicated removal rates of 99.5% and 80% for Cr(VI) and Cr(III), respectively. The high Cr(VI) removal was expected based on the liquid ion-exchange chemistry. Extraction of the positively charged Cr(III) cation was unexpected. See the earlier discussion of colloidal capture.

While the forms of the invention herein disclosed constitute presently preferred embodiments, many others are possible. It is not intended herein to mention all of the possible equivalent forms or ramifications of the invention. It is to be understood that the terms used herein are merely descriptive, rather than limiting, and that various changes may be made without departing from the spirit of the scope of the invention.

We claim:

1. A process for the extraction metal ions from a dilute aqueous solution comprising:
a. contacting the aqueous solution with an extraction solution comprising a metal extractant for ions, a diluent, and a modifier at a pH below 6, wherein ions are extracted from the aqueous solution, and wherein the ratio of aqueous solution to extraction solution (A/E) is above about 4/1;
b. separating the contacted solutions into a loaded extraction solution phase containing the metal ions bound with an extractant-metal bond and a detoxified aqueous phase reduced in metal ion content; and
c. separating the phases.

2. The process according to claim 1, wherein metal ions are stripped from the extraction solution phase.

3. The process according to claim 1, comprising the additional step of adjusting the pH to less than 6 by adding a strong acid.

4 The process according to claim 1, wherein the phases are separated via their mutual immiscibility and specific gravity difference.

5. The process according to claim 1, wherein the oxometal ion is stripped from the extraction solution phase by increasing the solution pH, wherein the extractant-metal bond is broken, recovering the metal as an aqueous metal salt concentrate phase.

6. The process according to claim 2, wherein the metal anions are stripped from the extraction solution phase by adding base.

7. The process according to claim 2, wherein the loaded extraction solution is contacted with base and water to strip metal ion to form a regenerated extraction solution and a product aqueous solution, and wherein about 10 vol % to about 99 vol % of the product aqueous solution is recycled to be contacted by the loaded extraction solution, water and base.

8. The process according to claim 7, wherein for metal ion stripping, the pH range is from about 11 to about 14.

9. The process according to claim 7 wherein water is added in the stripping step at a rate sufficient to maintain a substantially constant aqueous metal salt concentrate or an aqueous metal salt concentrate within a selected range.

10. The process according to claim 6, further comprising:
1. contacting the separated loaded extraction solution with base, water, and internally recycled product aqueous solution and mixing;
2. separating the mixture into a recycled extraction solution depleted in metal ion content and a product aqueous solution depleted in metal ion content;
3. recycling a portion of the product aqueous solution to step 1; and
4. separating another portion of the product aqueous solution from step 3 for metal ion recovery.

11. The process according to claim 10, wherein the regenerated extraction solution is recycled to the contacting step of claim 1.

12. The process according to claim 1, wherein chromium is extracted from the aqueous solution.

13. The process according to claim 1, wherein the extractant is a tertiary amine represented by the general formula, NR₁R₂R₃, where R₁, R₂, or R₃ may be the same or different and are selected from the group R₁═C₁-C₁₈, R₂═C₁-C₁₈, and R₃═C₁-C₁₈, total Cn is 9-40 or represented by the general formula NR₁R₂R₃R₄, where R₁, R₂, R₃, or R₄ may be the same or different and are selected from the group R₁═C₁-C₁₈, R₂═C₁-C₁₈, R₃═C₁-C₁₈ and R₄═C₀-C₁₈, and total Cn is 9-40; and comprises about 0.5 to about 30 w % of the total extraction solution.

14. The process according to claim 1, wherein Cr(VI) and Cr(III) are both extracted.

15. The process according to claim 14, wherein the metal ion extractants comprise from about 0.5 to about 30 wt % of the extraction solution.

16. The process according to claim 1, wherein the loaded extraction solution regeneration is achieved using a strong base to increase the pH.

17. The process according to claim 3, wherein the strong acid is selected from the group consisting of as H₂SO₄, HCl, H₂PO₄, CH₃SO₃H, HNO₃, and HBF₄.

18. The process according to claim 1, wherein the aqueous solution is the effluent from surface finishing operations.

19. The process according to claim 1, wherein the pH of the extraction and stripping circuits are automatically controlled.

20. The process according to claim 1, wherein for anion extraction the pH range is from about 2 to about 5.

21. The process according to claim 1, wherein the pH range is from about 2.5 to about 4.5.

22. The process according to claim 1, wherein the A/E ratio is at about 4/1 to about 20/1.

23. The process according to claim 1, wherein the A/E ratio is at about 6/1 to about 20/1.

24. The process according to claim 1, wherein the A/E ratio is at about 8/1 to about 20/1.

25. The process according to claim 1, wherein the diluent comprises an aliphatic or aromatic hydrocarbon, having about 5 to about 15 carbon atoms, and comprises from about 50 to about 99.5 wt % of the extraction solution.

26. The process according to claim 1, wherein the modifier comprises a long chain aliphatic, straight or branched chain hydrocarbon alcohol and comprises from about 0 to about 20 wt % of the extraction solution.

27. The process according to claim 1, wherein a mixer is used in the contacting and the mixer has a stirrer with a tip speed in the range of about 1.5 to about 7.5 m/sec and the residence time in the contacting ranges from about 0.1 to about 10 minutes.

28. A process for the simultaneous extraction of metal anion from an aqueous solution by means of ion pairing, and metal cation extraction by colloidal capture.

29. A process for the simultaneous extraction of metal anion (Cr(VI)) by ion pairing, and metal cation (Cr(III)) extraction by colloidal capture.

30. An apparatus for the extraction of metal anions from an aqueous solution comprising:
a. means for contacting the solution with an extraction solution comprising a metal extractant, a diluent, and a modifier, and mixing;
b. means for separating the mixture into a loaded extraction solution containing the metal ion and a detoxified aqueous solution reduced in metal ion content;
C. means for separating the solutions; and
d. means for recovering the metal ion from the extraction solution.

31. The apparatus according to claim 30, wherein the means for recovering the metal ion from the extraction solution phase comprises:
1. means for contacting the loaded extraction solution with a base, and water and mixing;
2. means for separating the mixture into a regenerated extraction solution reduced in metal ion content and a product aqueous solution increased in metal ion content;
3. means for recycling a portion of the product aqueous solution from the means for separating to the means for contacting the loaded extraction solution with a base and water for further mixing; and
4. means for removing product aqueous phase from the means for separating for recovering the metal ion from the product aqueous solution.
